(19) United States
(12) Patent Application Publication
(10) Pub. No.: US 2010/0192121 A1
(43) Pub. Date: Jul. 29, 2010

(54) DEBUGGING REMOTE FILES USING A VIRTUAL PROJECT

(75) Inventors: Aditya Unnithan, Seattle, WA (US); Sergey Dubinets, Bellevue, WA (US); C. Douglas Hodges, Sammamish, WA (US); Stefania I. Crivat, Redmond, WA (US); Anton Lapounov, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/358,244

(22) Filed: Jan. 23, 2009

(51) Int. Cl. G06F 9/44

(52) U.S. Cl. 717/103; 717/139

(57) ABSTRACT

A virtual project system is described herein that creates a virtual project to provide information during remote debugging similar to the project information available for local debugging. The virtual project contains each of a document's local and original Uniform Resource Identifiers (URIs) for documents that are downloaded and compiled locally. At debug-time, the virtual project system injects the virtual project with information resolved by the debugger, including the original URI and the locally compiled version of the document. This allows the virtual project to associate the local to original URI mappings so that when the IDE receives symbol information at debug-time and attempts to open the document that has the current debug context, the IDE opens the correct remote document rather than a local copy. This ensures that any changes made by the user during debugging affect the remote document, rather than the temporary local copy.

### BACKGROUND

Extensible Stylesheet Language (XSL) Transformation (XSLT) XSLT is a standard language for transforming Extensible Markup Language (XML) documents into new XML or “human-readable” documents. The new document may be in standard XML syntax or in another format, such as HTML, plain text, word processing documents, or spreadsheets. The XSLT processing model involves one or more XML source documents, one or more XSLT style sheets, an XSLT template processing engine (the processor), and a result document. The XSLT processor ordinarily inputs two files—an XML source document and an XSLT style sheet—and outputs a result document. The XSLT style sheet contains the XSLT program text (or “source code” in other languages) and is itself an XML document that describes a collection of template rules: instructions and other hints that guide the processor toward the production of the result document by emitting elements of the desired output format.

Debugging generally involves the process of running a program in an environment (e.g., a debugger) where a software developer can more easily find errors. The debugger may provide additional error logging, the ability to inspect values stored in variables dynamically at runtime, and so forth. Developers can define breakpoints at locations in source code where the developer wants to interrupt execution. When execution reaches the breakpoint, execution stops, and the debugger allows the developer to view and manipulate the program state. For data-driven languages, such as Extensible Stylesheet Language (XSL) and Extensible Markup Language (XML), debuggers often offer the ability to place data breakpoints. A data breakpoint is hit when data in a particular variable changes, or in some cases developers can specify a value for the breakpoint so that the breakpoint only hits when the variable holds that value.

Typically, software developers debug software applications in projects created within an Integrated Development Environment (IDE), such as Microsoft Visual Studio. A project stores information about the source files that make up an application, the location to place built binaries, the types of debug symbols to generate, and so forth. During debugging, a project makes it possible for the IDE to find symbols that align locations within executable binary files with lines in source files so that a software developer can diagnose problems in a familiar programming language (rather than machine code).

Unfortunately, problems with a software application often occur in the field on a computer that does not contain the project files. Typically, the developer distributes the binaries to many computers for testing and when a problem occurs, the software developer may come and view the problem without the benefit of symbols or source code. For example, Microsoft Visual Studio extensibility allows a developer to create a debugger and step through the execution of a file to find bugs in the file, possibly without an owning project, and possibly with a remote URL path, instead of downloading the file to disk beforehand. In addition, the Microsoft Visual Studio shell handles the opening of files specified by symbol information. When a software developer debugs a remote document, the symbol information contains the local filename associated with the remote file (e.g., in the Temporary Internet Files folder). Thus, when the shell attempts to open related files, the IDE will not find the files on the computer hosting the IDE where the problem has occurred.

For example, for the Extensible Stylesheet Language Transformation (XSLT) Debugger in Microsoft Visual Studio 2008, when the user opens a remote XSL stylesheet, sets a breakpoint inside a remote file, and starts debugging, the debugger will not break on the breakpoint since the filename of the open remote file (an http location) is different from the filename in the symbols (the local representation in the Temporary Internet Files folder). In addition, if a user opens a local XML document, sets a data breakpoint, requests to debug the XML document with a remote stylesheet, and starts debugging, the debugger will break but will open the local file with an obfuscated name. Even if debugging is successful, there are several problems with presenting the local file to the developer. First, because the file is local, any access permissions set on the original remote file will not apply. In addition, any edits that the software developer makes to correct identified problems will be lost when the debug session ends since the changes occur in the local, temporary copy of the file.

### SUMMARY

A virtual project system is described herein that creates a virtual project to provide information during remote debugging (e.g., locally debugging a remote file) similar to the project information available for local debugging. The virtual project contains each of a document's local and original Uniform Resource Identifiers (URIs). At debug-time, the virtual project system injects the virtual project with information that is resolved by the debugger: the original URI, if there is one, and the file location on disk. This allows the virtual project to associate the local to original URI mappings. When the IDE receives the symbol information at debug-time and attempts to open the file that has the current debug context, the IDE queries the virtual project with the filename to determine whether the virtual project will open the file. The virtual project then opens the file by asking the original owning project, or the miscellaneous files project, to open the original filename instead of the local filename.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the virtual project system, in one embodiment.

FIG. 2 is a flow diagram that illustrates the processing of the virtual project system when a user selects a file and begins debugging, in one embodiment.

FIG. 3 is a flow diagram that illustrates the processing of the virtual project system when the system receives a breakpoint notification, in one embodiment.

FIG. 4 is a block diagram that illustrates the relationship between the virtual project and an IDE, in one embodiment.

### DETAILED DESCRIPTION

A virtual project system is described herein that creates a virtual project to provide information during remote debugging similar to the project information available for local debugging. When a remote file, such as an XSL file, is downloaded to a local client and compiled, the compilation process produces an executable file on the local client and symbols that reference the local executable file. However, a user may not know about the local executable file, and may intend to debug and edit the remote original file. The virtual project contains each of a document's local and original Uniform Resource Identifiers (URIs). At debug-time, the virtual project system injects the virtual project with information that is resolved by the debugger: the original URI, if there is one, and the file location on disk or other storage media where the local file is stored. The local file storage location may be determined through an interface for identifying objects, such as the Component Object Model (COM) URLMoniker library. This allows the virtual project to associate the local file with the original URI mappings. When the IDE receives the symbol information at debug-time and attempts to open the local file that has the current debug context, the IDE queries the virtual project with the local file's filename to determine whether the virtual project will open the file. Projects can include collections of files or other resources as well as software instructions that implement a project interface exposed by the IDE for handling behavior associated with a group of resources. Some IDE's include a miscellaneous files project with which the IDE associates any files that are open but are not part of an existing open project. The virtual project opens the file by asking the original owning project, or the miscellaneous files project, to open the original file using the original filename instead of the local file using the local filename. Thus, the virtual project system hides the complexity of the local file from the user and allows the user to visualize, debug, and edit the remote file directly.

In some embodiments, the virtual project system visually displays the virtual project to a user by displaying it in a tree or other view of project information. For example, the Microsoft Visual Studio Solution Explorer may display the virtual project along with other projects. The user can interact with the virtual project by opening items, seeing the current active item, and so forth.

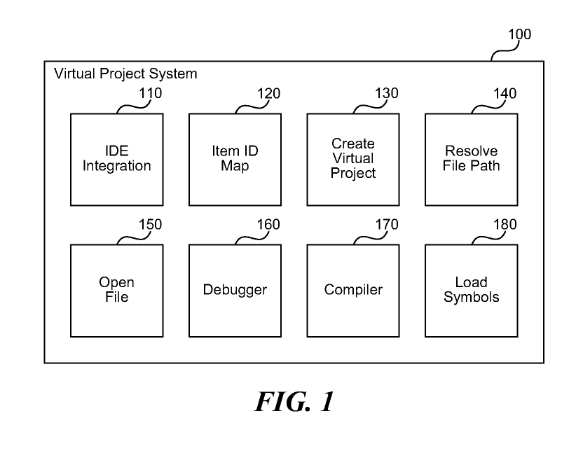

FIG. 1 is a block diagram that illustrates components of the virtual project system, in one embodiment. The virtual project system 100 includes an IDE integration component 110, an item ID map 120, a create virtual project component 130, a resolve file path component 140, an open file component 150, a debugger component 160, a compiler component 170, and a load symbols component 180. Each of these components is described in further detail herein.

The IDE integration component 110 facilitates the integration of the virtual project system 100 into an existing IDE for editing software code. For example, the IDE integration component 110 may provide a user interface integrated within the IDE, command output into an output window, the ability to respond to requests for information from the IDE (e.g., to display icons related to displayed controls), and so forth. Many IDEs provide extensibility interfaces through which the IDE integration component 110 can integrate with the IDE. For example, as described in detail herein, the Microsoft Visual Studio IDE provides published interfaces for adding projects and other integration into the IDE.

The item ID map 120 is a data store that maps identifiers for files managed by the virtual project system 100 with files included in other projects. Files handled by the virtual project system 100 are typically included in an original project, and the virtual project system 100 is used to provide an association with the original file and/or project during debugging on a computer system other than where the original file and project are stored. Some IDEs, such as Microsoft Visual Studio, expect each item managed by a project to have an identifier, and the item ID map 120 associates the identifier provided to the IDE for a file through the virtual project system 100 with the item identifier of the file in the original project. The item ID map can be any suitable data store, such as an in-memory list, a hash table, a database, or a data file.

The create virtual project component 130 creates the virtual project and invokes the IDE integration component 110 to integrate the virtual project with the IDE. The component 130 can be invoked when a user starts a debugging session, although other conditions where information about remote files is requested can also cause the IDE to invoke the component 130. For example, a symbol or other search may benefit from information from a remote file that may lead the virtual project system 100 to create the virtual project.

The resolve file path component 140 receives requests from the IDE to load a particular file and accesses the item ID map 120 to determine whether the file is handled by the virtual project system 100. If the file is handled by the virtual project system 100, then the resolve file path component 140 uses the mapping information in the item ID map 120 to identify the original file and invokes the original project to which the file belongs (or a catch-all project called the miscellaneous files project) to open the file. The received request may reference a local file path while the file opened by the component 140 in the process of remapping it to the original project may be a related but remotely stored file that is accessed via a remote file path. Thus, the resolve file path component 140 ensures that the correct file is opened to satisfy the IDE's request regardless of the received path.

The open file component 150 handles opening files. Each project may have its own file opening mechanism. For example, some projects may store files in a database while others may access files via a particular protocol, such as HTTP. The virtual project system 100 maps local paths used to access files (such as may be stored in a PDB) to a remote location for the file. Even though the virtual project system 100 may identify the original location of the file, the system uses the open file component 150 to defer the actual opening of the file to the project or component that is able to open the file once the correct path to the remotely stored original file is known. In this way, the virtual project system 100 can cooperate with many different project types to handle file name resolution.

The debugger component 160 handles debugging sessions, including creating, managing, and tearing down debugging sessions. The debugger component 160 may provide events or other notifications to other components through the IDE integration component 110. For example, when a debugging session begins, the debugger component 160 may send a debug start notification to allow any interested components to perform initial tasks. For example, upon receiving a debug start notification, the IDE integration component 110 of the virtual project system 100 can invoke the create virtual project component 130 to create the virtual project and add it to the user interface of the IDE. As another example, the IDE may use the notification to inject instructions related to breakpoints (e.g., interrupt 3) into the debug executable.

When breakpoints are hit due to particular breakpoint conditions being met by the executable the debugger component 160 is debugging, the debugger may send a debug breakpoint notification. The debug breakpoint notification provides an opportunity for the virtual project system 100 to load symbols files and resolve the paths of any remote files related to the location of the breakpoint.

When the debug session is finished, either because the debugged executable exits or the user terminates the debug session, the debugger may provide a debug end notification. The debug end notification allows components to clean up any data structures or other resources opened during the debug session. For example, the virtual project system 100 may invoke the create virtual project component 130 to tear down the virtual project and remove it from the IDE.

The compiler component 170 builds debuggable executable files based on one or more source files. In the case of an XML solution, the compiler component 170 builds and executable that can perform the translation specified by an XSL file to a particular input XML file to produce the desired output. The Microsoft Visual Studio IDE provides an executable host that is used by all XML-based solutions and compiles DLLs that the executable host loads. Thus, the compiler component 170 may be capable of producing a variety of different types of executable output, and the term executable file as used herein refers not just to files with an EXE extension, but files in any runable form, such as DLLs executed by a host EXE file.

The load symbols component 180 loads symbols related to an executable file that associate locations and data in the executable file with locations and variables in one or more source files. For example, a particular point of execution may be related to a particular rule in an XSL file, and the symbols associate the two. Symbols are typically a by-product of the compiling process performed by the compiler component 170. While the compiler component 170 is creating the executable file, the component 170 also creates data structures that store the symbols. The symbols allow the debugger component 160 to relate points of execution in the running executable file with the corresponding locations in the source files.

Although components are shown within the virtual project system 100, those of ordinary skill in the art will recognize that various component configurations are possible within the scope of the system described. For example, in an embodiment the IDE provides a compiling component, debugging component, and symbol loading component external to the virtual project system 100 that the virtual project system 100 invokes or that invoke the virtual project system 100 as needed. Nevertheless, such components perform the same or similar functions to those described herein.

The computing device on which the system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### Remote Debugging

Typically, a software developer begins remote debugging by specifying a remote XSL file and an XML file (that may also be remotely stored) associated with the XSL file using a Hypertext Transport Protocol (HTTP) path in an IDE on a computer that does not have the original project. The IDE downloads the remote XSL file, compiles the file into a Dynamic Link Library (DLL) with associated symbols in a Program Database (PDB) file. Although symbol files typically contain pointers to the executable and source files, limitations of the PDB file do not allow HTTP paths to be stored there. Thus, the PDB file generated by the compilation process contains references to the locally downloaded XSL file rather than the original remote file. The developer debugs the program by placing breakpoints in the XSL file via the IDE that are associated with the remote XSL file. The virtual project system provides a connection between the remote XSL file the developer is debugging and the local copy of the remote XSL file used to compile and produce symbols.

When an IDE attempts to open a file, the IDE typically asks each open project whether that project has information about the file and can handle the open request. If no projects will open the file, then the IDE may create a miscellaneous files project and open the file or alternatively display an error. By creating a virtual project, the virtual project system provides a project that will respond to the open request. Because the virtual project is aware of the remote nature of the file, the virtual project can open the file from the correct remote location when responding to the open request, even though the open request contains a local path to the file. Because the actual remote file is open and not a local copy, changes made by the software developer can be saved to the remote file and will not be lost when debugging ends and the IDE deletes the temporary local files.

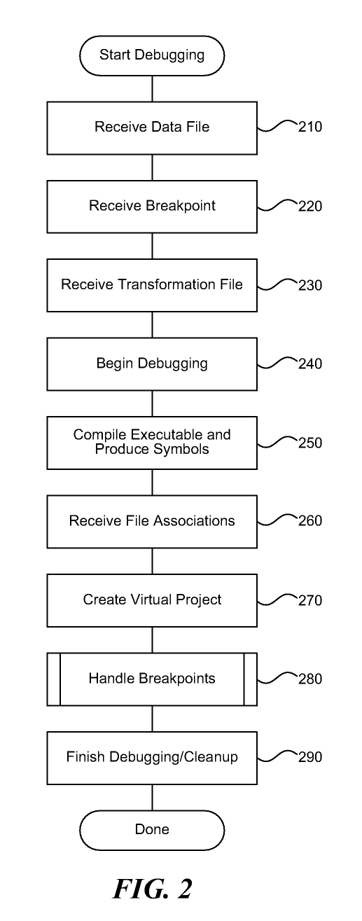

FIG. 2 is a flow diagram that illustrates the processing of the virtual project system when a user selects a file and begins debugging, in one embodiment. In block 210, the system receives from a user at a local client information identifying a file to debug, wherein the file is stored by a remote host. For example, a user may open an XML file through the user interface of an IDE to begin a process of debugging the XML file. Continuing in block 220, the system optionally receives one or more breakpoints in the identified file from the user. For example, the IDE may load the file and display the contents to the user so that the user can select one or more areas of the file to place breakpoints. Continuing in block 230, the IDE receives a transformation associated with the file. For example, the IDE may prompt the user for an XSL file or other information that describes or identifies a transform to use on the identified XML file.

Continuing in block 240, the system begins debugging. For example, the system may receive a debug start notification through the IDE based on actions of the user. Continuing in block 250, the system compiles the identified file for debugging, producing an executable file and one or more symbol files. For example, the IDE may copy the identified XSL locally, compile it using a compiler, and store a DLL and PDB file as output. Continuing in block 260, the system receives one or more file associations as a result of compiling that specify the relationship between one or more files retrieved from the remote host and one or more files stored on the local client. For example, the file associations may indicate that a local DLL file was produced by compiling a particular local copy of a remote XSL file. When the DLL is debugged, the associations provide a link between the local copy of the XSL file and the remote location from which the XSL file originated. Continuing in block 270, the system creates a virtual project in the IDE that maps files on the local client to files on the remote host based on the received file associations. The system may receive a debug start event based on the execution of a debugging executable (e.g., Microsoft.XSL.Debugger.Host.exe) that loads the compiled DLL.

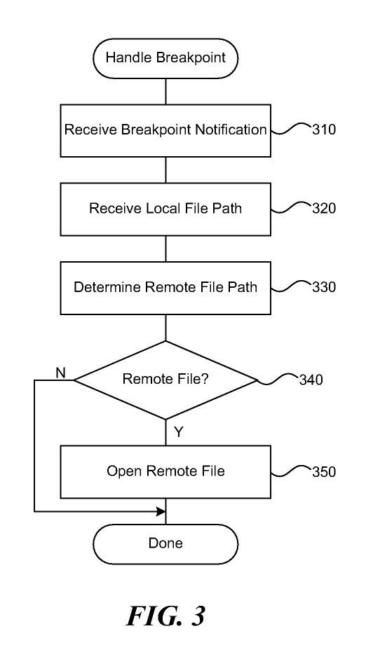

Continuing in block 280, the system receives one or more breakpoint notifications based on the breakpoints received from the user and the execution of the executable file, as further described with reference to FIG. 3. Continuing in block 290, debugging concludes, and the system removes the virtual project from the IDE and cleans up any associated resources. For example, the system may save changes the user made during debugging to any loaded remote files. The changes are saved directly to the remote file that was loaded by the IDE through the virtual project instead of any local copy of the remote file. After block 290, these steps conclude.

FIG. 3 is a flow diagram that illustrates the processing of the virtual project system when the system receives a breakpoint notification, in one embodiment. These steps are invoked when a user is debugging, and the conditions of one or more breakpoints set by the user are met by a running executable file. Breakpoints can also occur based on exceptions or other non-user-related events. In block 310, the system receives a breakpoint notification based on an occurrence of a user-specified condition, wherein the breakpoint contains information about a location in an executable file where the condition occurred. For example, the user may set a data breakpoint on a location in an XML file, and the breakpoint notification may specify that the executable file has reached a point that is modifying that location.

Continuing in block 320, the system receives a local file path that specifies a source file corresponding to the breakpoint information. For example, the system may receive a local file path stored in a symbol file (e.g., a PDB file) associated with the running executable file. Continuing in block 330, the system uses a virtual project to determine whether the received local file path corresponds to a remote file path associated with the running executable. For example, the system may create the virtual project when debugging begins and store a mapping between local and remote files related to the running executable file in the virtual project. Continuing in decision block 340, if the system determines that the received local file path associated with a local copy of an original remote file corresponds to a remote file path to the original remote file associated with the running executable, then the system continues at block 350, else these steps conclude.

Continuing in block 350, the system opens the remote file path and displays a graphical representation of the remote file to the user for debugging the breakpoint. For example, the system may look up an identifier corresponding to the original file in another project and invoke the other project to open the file. A user may have the original project available on the debugging computer system (e.g., the local system providing the IDE), or the IDE may create a miscellaneous files project that acts as a repository for files not associated with any other project. Even though the local file may be an identical copy of the remote file, it is beneficial for the IDE to open the file using the remote file path so that the IDE will save to the remote file via the remote file path any changes that the developer makes to the file. The IDE will typically clean up the local file when the debugging session concludes, so the IDE would discard any changes made to the local file (as happens in existing systems). Alternatively or additionally (e.g., to reduce network usage), with IDE support the virtual project system can provide information about the local and remote paths to the IDE so that the IDE opens the local file but saves changes to the remote file path. After block 350, these steps conclude.

### IDE Integration

Following is an example of integrating the virtual project system with the Microsoft Visual Studio IDE. The Microsoft Visual Studio IDE provides an extensibility model through which software developers can add new elements to a project hierarchy within the IDE by providing an implementation of the IVsHierarchy, IVsProject (to manage items within a project), and IVsUIHierarchy (to redirect commands to the appropriate hierarchy window instead of the standard command handler) interfaces that the IDE can invoke. In some embodiments, the virtual project system implements these three interfaces (e.g., using a COM object or through .NET inheritance) to create the virtual project hierarchy (e.g., when the IDE invokes the interfaces to inform the system that the IDE has compiled a file), add the visual representation of the virtual project to the Microsoft Visual Studio Solution Explorer, and clean up the virtual project after debugging has finished.

Although Visual Studio allows a developer to add a hierarchy to the Solution Explorer, the developer has to define each of the project and hierarchy based commands. Opening an item, for example, is a project-based action. In some embodiments, the virtual project system implements IVsProject.OpenItem (defined by the Microsoft Visual Studio IDE) to open requested items through either the original project that owns the item or the miscellaneous files project if there is no owning project. Transferring the items from the original project to the virtual project would prevent the user from opening the file from both the virtual project and the original project, so as noted herein the an example embodiment of the virtual project system provides a shortcut or reference to the original project, and leaves the original project intact. Alternatively or additionally, the virtual project system may open the file directly instead of through the original project.

In some embodiments, the IVsProject.IsDocumentInProject implementation informs the IDE that the virtual project only handles local files. This ensures that the IDE does not attempt to open Internet or other remote files through the virtual project system and thereby violate security measures. Although the virtual project system opens remote files, the paths passed by the IDE to be opened are local paths that the virtual project system maps to remote paths. In the IVsProject.OpenItem implementation, the virtual project system delegates the opening of these files to either the original project or the miscellaneous files project and passes the original file path (which could be an HTTP path) to that project's IVsProject.OpenItem implementation.

The IVsHierarchy interface contains methods that the IDE invokes through which the system creates the virtual hierarchy, adds a visual representation of the virtual project in the Solution Explorer, and cleans up after debugging has finished. When a debug session starts, the virtual project system uses the IVsSolution.AddVirtualProject method for adding an IVsHierarchy implementation to the IDE. Similarly, when a debug session concludes, the virtual project system uses the IVsSolution.RemoveVirtualProject method to remove the virtual project from the IDE. The IVsUiHierarchy interface contains methods for responding to hierarchy-based commands for actions such as double-clicks.

The IVsHierarchy, IVsUIHierarchy, and IVsProject interfaces do not enforce or suggest methods of implementation; the virtual project system can implement the hierarchy as a linked list of nodes that represent the files or a tree, which is the common implementation.

In order to get and set properties on each node in the hierarchy, the Microsoft Visual Studio IDE calls the IVsHierarchy.GetProperty and IVsHierarchy.SetProperty methods with an item identifier and property identifier. The virtual project system contains a dictionary that maps item identifiers to hierarchy nodes (HierarchyNode). A hierarchy node contains pointers to its next sibling, previous sibling, parent, first child, and last child, as well as a hash set of its children to quickly return properties requested by the shell. A hierarchy node also contains a “moniker” and a “local moniker”; for downloaded files, the moniker will be the original URI and the local moniker will be the local (e.g., cached) file. For other files, these properties will be the same.

Microsoft Visual Studio provides the LanguageService class for adding classes that handle language specific features. In some embodiments, the virtual project system provides a LanguageService method that is called by the method that launches debug targets. The method populates the virtual project hierarchy with the current debugging documents before adding the hierarchy to the Solution Explorer.

Microsoft Visual Studio identifies each open item with an item identifier that can be specified by a project. The virtual project system may remove the files from the original project and place them in the virtual project during debugging, but if the developer also has the original project open (e.g., such as when debugging locally at the original file location) the absence of these files may be confusing. In some embodiments, the virtual project system specifies the item identifier of the original project file when handling remote files during debugging. In this way, the Running Document Table maintained by Visual Studio stores the item identifier of the original project, so that the user can still open the project from the original project as well as from the virtual project. In such embodiments, the virtual project contains a link or reference to the original files rather than containing the files themselves. In some cases, the virtual project system may not know whether debugging is occurring locally or remotely and avoids interfering with behavior that the developer expects (e.g., finding the files in the original project) when debugging locally.

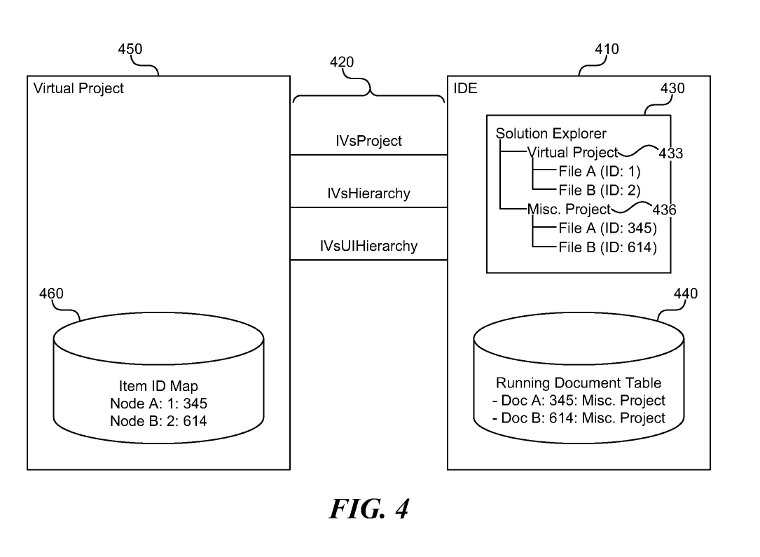

FIG. 4 is a block diagram that illustrates the relationship between the virtual project and an IDE, in one embodiment. The IDE 410 exposes interfaces 420 through which third party developers can extend the functionality of the IDE 410. The virtual project system implements or provides an extension 450 that uses the interfaces 420 to communicate with the IDE 410. In the illustrated example, the IDE 410 contains a solution explorer window 430 and a running document table 440. The solution explorer window 430 displays the projects related to a particular solution, including the virtual project 433 and a miscellaneous project 436. The solution explorer window 430 may also contain an original owning project (not shown). As shown, the virtual project contains two files that refer to files in the miscellaneous project. The running document table 440 contains a list of each open file, and shows that two files from the miscellaneous project are open.

The virtual project extension 450 contains an item ID map 460 that associates remote file identifiers with local file identifiers. When the virtual project extension 450 receives a request through the interfaces 420 to open a file for which the extension 450 has mapped information, the extension 450 invokes the original project (or the miscellaneous project displayed in the Figure) to open the file using the identifiers given to the file by the original project. In this way, local paths stored in a symbol file for a local executable related to a remotely stored original file by the IDE 410 will be opened correctly from a remote host.

From the foregoing, it will be appreciated that specific embodiments of the system have been described herein for purposes of illustration, but that various modifications may be made without deviating from the spirit and scope of the invention. Although XSLT debugging has been described, the virtual project system can be adapted to other environments where debugged files may have one path but associated files may have another, such as when remotely debugging managed code, Sun Java code, and so forth. Accordingly, the invention is not limited except as by the appended claims.

I/We claim:

1. A computer-implemented method for remotely debugging a data file in an integrated development environment, the method comprising:
receiving from a user at a local client information identifying a data file to debug, wherein the data file is stored at a remote host;
receiving information identifying a transformation file associated with the data file;
starting a debugger to debug the transformation file operating on the data file;
compiling the identified data file for debugging, wherein compiling produces at least one executable file and one or more symbol files;
receiving one or more file associations as a result of compiling that specify a relationship between one or more files retrieved from the remote host and one or more files stored on the local client; and
creating a virtual project in the integrated development environment that maps files on the local client to files on the remote host based on the received file associations so that requests to open a file will open a corresponding file on the remote host rather than a related file on the local client,
wherein the preceding steps are performed by at least one processor.

2. The method of claim 1 wherein the data file is an Extensible Markup Language (XML) file and the transformation file is an Extensible Stylesheet Language (XSL) file, each stored on the remote host.

3. The method of claim 1 wherein compiling comprises copying the transformation file to the local client, producing executable code stored in a DLL file, and producing symbols stored as a PDB file.

4. The method of claim 1 wherein the file associations specify at least one relationship between a locally stored file in a temporary download location of the local client and a remotely hosted file selected by the user for debugging.

5. The method of claim 1 wherein creating a virtual project is performed in response to receiving a debug start notification from the integrated development environment.

6. The method of claim 1 further comprising receiving one or more breakpoints in the identified data file from the user.

7. The method of claim 6 further comprising receiving one or more breakpoint notifications based on the breakpoints received from the user and the execution of the executable file.

8. The method of claim 1 further comprising, receiving an indication that debugging is complete, updating the remotely stored data file with any changes made, and removing the virtual project from the integrated development environment.

9. The method of claim 1 further comprising receiving one or more edits from the user during debugging and storing the edits in a remote file identified by the file associations.

10. A computer system for identifying remote files associated with a local executable file, the system comprising:
a processor and memory configured to execute software instructions;
an IDE integration component configured to integrate a virtual project system into an existing integrated development environment for debugging software instructions;
an item ID map configured to map identifiers for files managed by the virtual project system with files included in other projects associated with the integrated development environment;
a create virtual project component configured to create a virtual project and invoke the IDE integration component to integrate the virtual project with the integrated development environment; and
a resolve file path component configured to receive requests from the integrated development environment to load a particular file and access the item ID map to map the file to a remote file.

11. The system of claim 10 wherein the IDE integration component is further configured to provide a user interface integrated within the integrated development environment and to respond to requests for information from the IDE.

12. The system of claim 10 wherein the IDE integration component implements one or more extensibility interfaces defined by the integrated development environment for adding projects to the integrated development environment.

13. The system of claim 10 wherein the create virtual project component is further configured to receive notification when the integrated development environment begins a debugging session.

14. The system of claim 10 wherein the resolve file path component is further configured to replace a local file path to which a remote file was downloaded with an original path of the remote file.

15. The system of claim 10 further comprising a debugger component configured to handle debugging sessions, including creating, managing, and tearing down sessions and providing notifications of a current state to other components through the IDE integration component.

16. The system of claim 10 further comprising a compiler component configured to build debuggable executable files based on one or more source files, wherein the compiler component compiles a remotely hosted file into a locally stored executable file.

17. The system of claim 10 further comprising a load symbols component configured to load symbols related to an executable file, wherein the symbols associate locations and data in the executable file with locations and variables in one or more source files.

18. A computer-readable storage medium comprising instructions for controlling a computer system to handle a breakpoint in a remotely debugged file, wherein the instructions, when executed, cause a processor to perform actions comprising:
receiving a breakpoint notification based on an occurrence of a user-specified condition, wherein the breakpoint contains information about a location in an executable file where the condition occurred.
receiving a local file path that specifies a source file corresponding to the breakpoint information
invoking a virtual project to determine whether the received local file path corresponds to a remote file path associated with the executable file; and
in response to a determination that the received local file path corresponds to a remote file path associated with the running executable, opening 350 the remote file path and displaying a graphical representation of the remote file to the user for debugging the breakpoint.

19. The computer-readable medium of claim 18 wherein the breakpoint notification corresponds to a data breakpoint associated with a location in an XML file identified by the user.

20. The computer-readable medium of claim 18 wherein the local file path is stored in a symbol file associated with a locally stored executable file, and wherein the locally stored executable file was copied from a remote location corresponding to the remote file path.
